(19) United States
(12) Patent Application Publication
(10) Pub. No.: US 2014/0060109 A1
(43) Pub. Date: Mar. 6, 2014

(54) VENDING MACHINE WITH TEMPERATURE CONTROL MODULE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: YUN-LUNG CHEN, New Taipei (TW); CHUNG CHAI, New Taipei (TW); DA-LONG SUN, Wuhan (CN); HAI HUANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/875,280

(22) Filed: May 2, 2013

(30) Foreign Application Priority Data
Aug. 29, 2012 (CN) 201210311916X

(51) Int. Cl. G07F 9/10

(52) U.S. Cl. CPC G07F 9/105
USPC 62/498

(57) ABSTRACT

A vending machine includes a cabinet and a temperature control module. The temperature control module includes an evaporator, a compressor, and a condenser. The cabinet includes a sliding rail. The temperature control module further includes a wheeled bracket. The evaporator, the compressor, and the condenser are secured to the bracket. The components of the temperature control module, as a single unit, can be installed and removed without any dismantling operation being carried out to the frame of the vending machine.

### BACKGROUND

1. Technical Field

The present disclosure relates to vending machines, and particularly to a vending machine with a temperature control module.

2. Description of Related Art

A temperature control module is used in a vending machine to control temperature of goods. Generally, the temperature control module includes an evaporator, a compressor, and a condenser. In assembly, each of the evaporator, the compressor, and the condenser is secured to a cabinet of the vending machine, and the evaporator. The compressor, and the condenser are secured to a number of pipes by soldering. However, in disassembly of the temperature control module from the cabinet, the evaporator, the compressor, and the condenser must be dismantled from the cabinet, which is inconvenient. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a vending machine.

FIG. 2 is an exploded, isometric view of a temperature control module of the vending machine of FIG. 1.

FIG. 3 is an isometric view of a heat insulation module of the vending machine of FIG. 1.

FIG. 4 is an exploded, isometric view of the heat insulation module of the vending machine of FIG. 1.

FIG. 5 is an assembled view of the vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

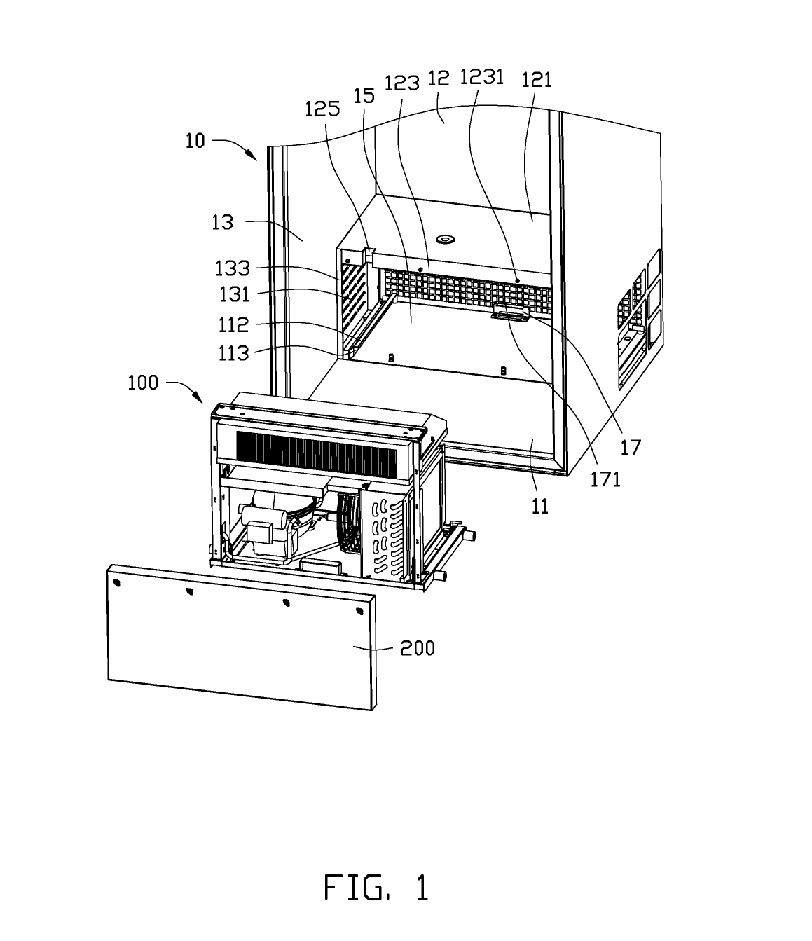

FIG. 1 shows a vending machine in accordance with an embodiment. The vending machine includes a cabinet 10 (only a part of the cabinet 10 is shown in FIG. 1), a temperature control module 100, and a heat insulation module 200.

The cabinet 10 includes a bottom plate 11, a rear plate 12, and two side plates 13 opposite to each other. In one embodiment, the bottom plate 11 is substantially perpendicular to the rear plate 12 and the two side plates 13, and the rear plate 12 is substantially perpendicular to the two side plates 13.

The cabinet 10 further includes two sliding rails 112, each adjacent to each of the two side plates 13. A sliding channel 113 is defined by each sliding rail 112 and the bottom plate 11 for mounting the temperature control module 100.

Each side plate 13 includes a ventilation portion 131. A top flange (not shown) and a side flange 133 extend from adjacent two edges of the ventilation portion 131. In one embodiment, the ventilation portion 131 is rectangular, the top flange is substantially perpendicular to the side flange 133, and the top flange and the side flange 133 are substantially perpendicular to the side plates 13. A top cover 121 substantially perpendicularly extends from the rear plate 12. The top cover 121 is substantially parallel to the bottom plate 11. The top cover 121 includes a mounting plate 123. The mounting plate 123 is away from the rear plate 12 and substantially parallel to the rear plate 12. The top cover 121 defines a receiving slot 125 extending towards the rear plate 12. The top cover 121 defines a plurality of mounting holes 1231. The top cover 121 abuts the top flange. The mounting plate 123 abuts an inner surface of the side flange 133. A receiving space 15 is defined cooperatively by the top cover 121, the bottom plate 11 and the two side plates 13 for receiving the temperature control module 100. A blocking member 17 is secured to the bottom plate 11 and adjacent to the rear plate 12. The blocking member 17 includes two blocking pieces 171, each blocking piece 171 is substantially parallel to the bottom plate 11.

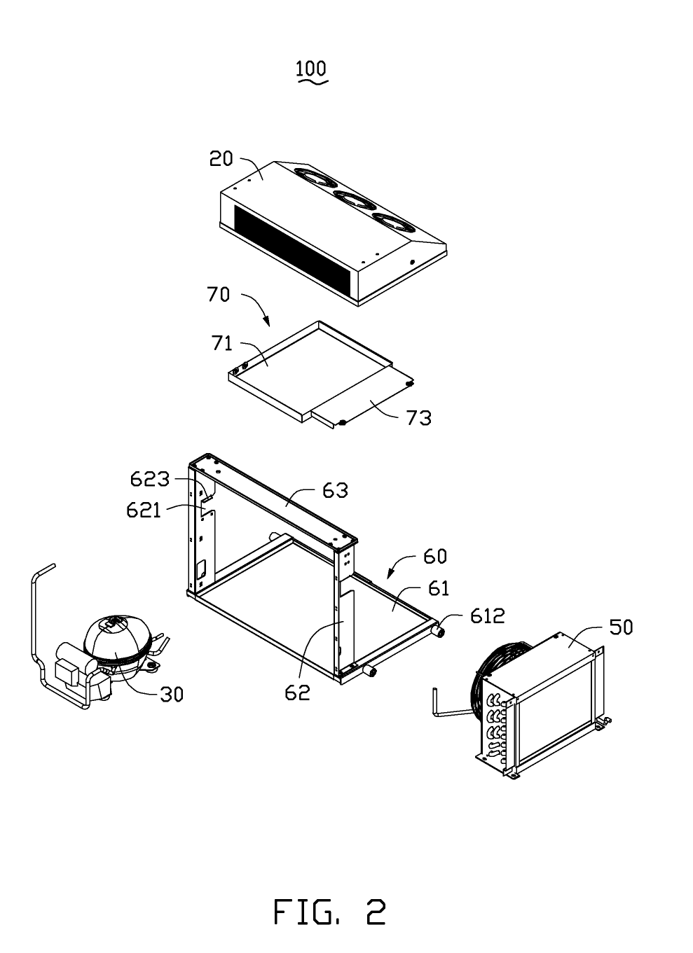

Referring to FIG. 2, the temperature control module 100 includes an evaporator 20, a compressor 30, a condenser 50, a bracket 60, and a dividing member 70.

The bracket 60 includes a base 61, two supports 62 secured to the base 61, and a pulling plate 63 secured to the two supports 62. Two wheels 612 are secured to each opposite side of the base 61. Each of the two supports 62 defines a cutout 621. A maintaining piece 623 extends from a top edge of the cutout 621. In one embodiment, the pulling plate 63 is substantially parallel to the base 61, each of the two supports 62 is substantially perpendicular to the base 61 and the pulling plate 63, and the maintaining piece 623 is substantially parallel to the base 61. A distance between the two blocking pieces 171 is substantially equal to a height of the base 61. A width of the receiving slot 125 is substantially equal to a width of each support 62.

The dividing member 70 includes a dividing plate 71 and an installation plate 73 extending from a side of the dividing plate 71.

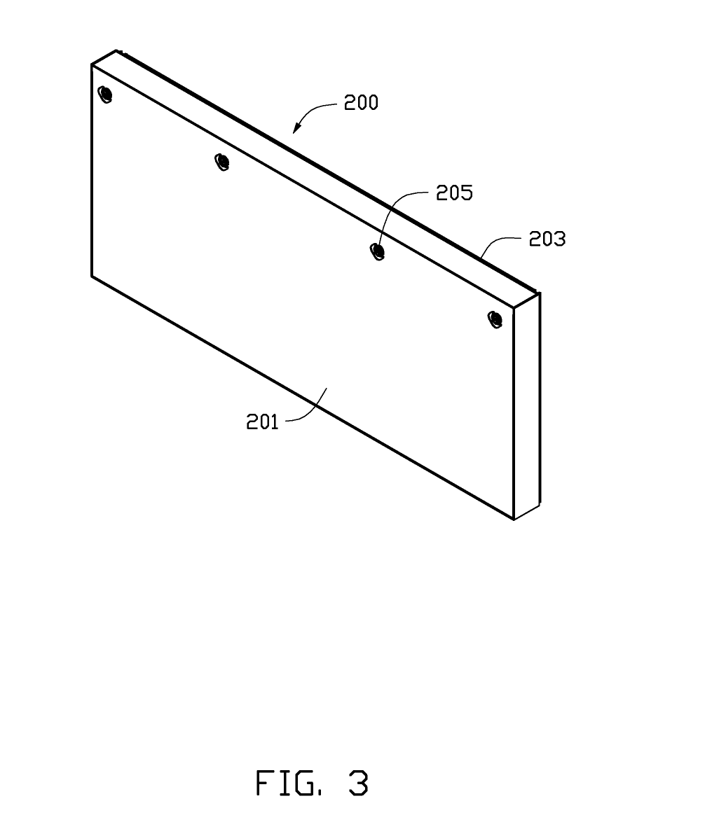

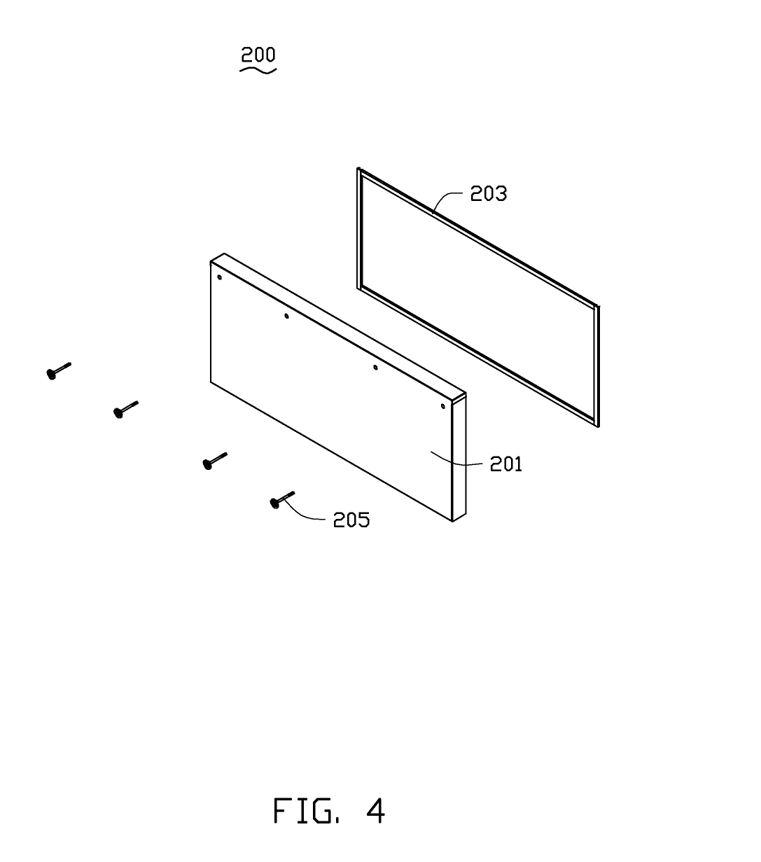

FIG. 3 and FIG. 4 show the heat insulation module 200 which includes a heat insulation plate 201 and a sealing washer 203 attached to a surface of the heat insulation plate 201.

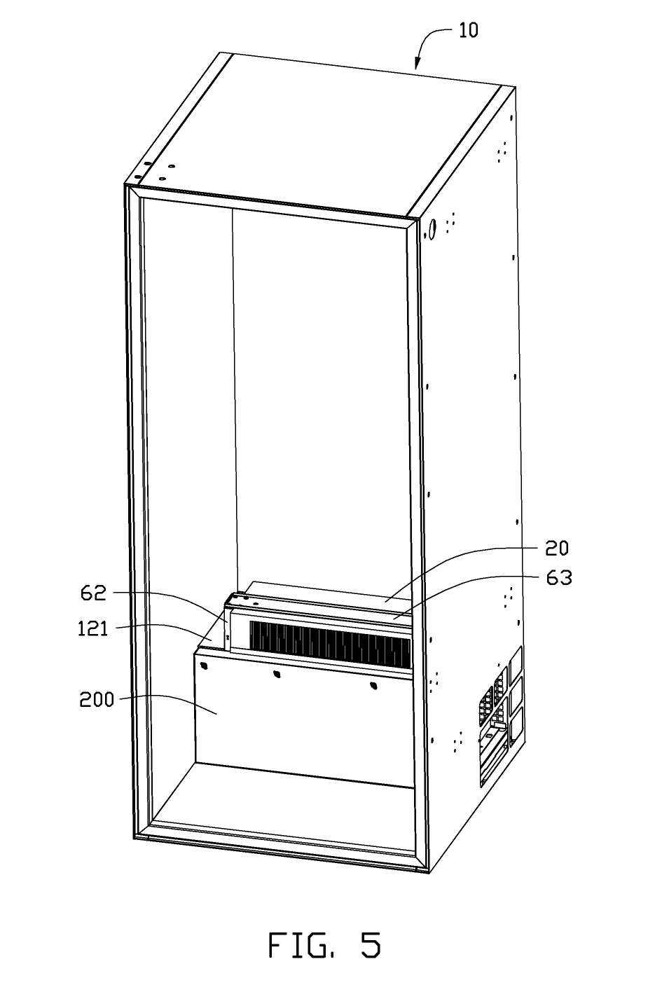

FIG. 5 shows that, in assembly of the temperature control module 100, the compressor 30 and the condenser 50 are secured to the base 61. The dividing plate 71 is secured to one of the two supports 62. The installation plate 73 is secured to the condenser 50. The evaporator 20 is secured to the maintaining pieces 623 of the two supports 62. The dividing member 70 separates the evaporator 20 from the compressor 30 and the condenser 50. A distance between the dividing member 70 and a bottom surface of the evaporator 20 is substantially equal to a height of the top cover 121.

In assembly of the temperature control module 100 to the cabinet 10, the temperature control module 100 is placed in the cabinet 10 and the wheels 612 are aligned with the sliding channel 113. The temperature control module 100 is pushed to slide the wheels 113 along the sliding channel 113. The top cover 121 is moved relative to the temperature control module 100 between the evaporator 20 and the dividing member 70, until the temperature control module 100 is blocked by the blocking member 17. The temperature control module 100 is further moved to bias the base 61 to elastically deform the two blocking pieces 171. When the temperature control module 100 is between the two blocking pieces 171, the two blocking pieces 171 rebound to engage the temperature control module 100 therebetween and the temperature control module 100 is thus received in the receiving space 15. A part of each support 62 is received in the receiving slot 125, and the evaporator 20 is above the top cover 121. The heat insulation module 200 is moved to be adjacent to the temperature control module 100, and the sealing washer 203 abuts an outer surface of each of the side flange 133, the mounting plate 123, and the base 61. A plurality of locking members 205 is engaged in the mounting hole 1231 through the heat insulation module 200. The heat insulation module 200 is secured to the top cover 121 and covers the receiving space 15.

In disassembly, each of the locking member 205 is disengaged from the mounting hole 1231. The temperature control module 100 as a single unit can be slid out of the receiving space 15 along the sliding channel 113.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A vending machine, comprising:
a cabinet comprising a sliding rail; and
a temperature control module comprising an evaporator, a compressor, a condenser, and a bracket;
wherein the bracket comprises a wheel; the evaporator, the compressor, and the condenser are secured to the bracket; the bracket is slidably mounted to the cabinet along the sliding rail; and the bracket is slidable relative to the cabinet to slide the evaporator, the compressor, and the condenser together.

2. The vending machine of claim 1, wherein the bracket further comprises a base, two supports secured to the base, and a pulling plate secured to the two supports; the temperature control module further comprises a dividing member, the compressor and the condenser are secured to the base; a first end of the dividing member is secured to one of the two supports, a second end of the dividing member is secured to the condenser; and the evaporator is secured to the pulling plate and the two supports above the dividing member.

3. The vending machine of claim 2, wherein the dividing member comprises a dividing plate and an installation plate extending from the dividing plate; the dividing plate is secured to the two supports; the installation plate is secured to the condenser; and the dividing plate is located between the evaporator and the compressor.

4. The vending machine of claim 3, wherein each of the two supports defines a cutout, and a maintaining piece extends from an edge of the cutout and is substantially parallel to the pulling plate; and the evaporator is secured to the maintaining piece.

5. The vending machine of claim 3, wherein the cabinet comprises a bottom plate, a rear plate, and two side plates, the bottom plate is substantially perpendicular to the rear plate and the two side plates, and the rear plate is substantially perpendicular to the two side plates; the cabinet further comprises a top cover extending from the rear plate, and the top cover is substantially parallel to the bottom plate; and the top cover, the rear plate, and the two side plates cooperatively define a receiving space for receiving the temperature control module.

6. The vending machine of claim 5, wherein the dividing member, the compressor, and the condenser are received in the receiving space, and the evaporator is located above the top cover.

7. The vending machine of claim 5, wherein the top cover comprises a mounting plate substantially parallel to the rear plate, the mounting plate defines a receiving slot towards the mounting plate, and a part of each of the two supports is received in the receiving slot.

8. The vending machine of claim 5, wherein a height of the top cover is substantially equal to a distance between the dividing member and a bottom surface of the evaporator.

9. The vending machine of claim 5, wherein the sliding rail is secured to the bottom plate, a sliding channel is defined by the sliding rail and the bottom plate, and the wheel is slidably received in the sliding channel; the bottom plate comprises a blocking member, the blocking member comprises two blocking pieces, and the base is positioned between the two blocking pieces.

10. The vending machine of claim 5, further comprising a heat insulation plate and a sealing washer, wherein each of the two side plates comprises a flange; the receiving space defines an opening; and the sealing washer is secured to the mounting plate and the flange and covers the opening.

11. A vending machine, comprising:
a cabinet comprising a sliding rail; and
a temperature control module comprising an evaporator, a compressor, a condenser, and a bracket;
wherein the evaporator, the compressor, and the condenser are secured to the bracket, the bracket is slidably mounted to the cabinet along the sliding rail, and the bracket is slidable relative to the cabinet to slide the evaporator, the compressor, and the condenser together; the bracket comprises a wheel, a base, two supports secured to the base, and a pulling plate secured to the two supports; the temperature control module further comprises a dividing member, the compressor and the condenser are secured to the base; a first end of the dividing member is secured to one of the two supports, a second end of the dividing member is secured to the condenser; and the evaporator is secured to the pulling plate and the two supports and is above the dividing member.

12. The vending machine of claim 11, wherein the dividing member comprises a dividing plate and an installation plate extending from the dividing plate; the dividing plate is secured to the two supports; the installation plate is secured to the condenser; and the dividing plate is located between the evaporator and the compressor.

13. The vending machine of claim 12, wherein each of the two supports defines a cutout, and a maintaining piece extends from an edge of the cutout and is substantially parallel to the pulling plate; and the evaporator is secured to and on the maintaining piece.

14. The vending machine of claim 12, wherein the cabinet comprises a bottom plate, a rear plate, and two side plates, the bottom plate is substantially perpendicular to the rear plate and the two side plates, and the rear plate is substantially perpendicular to the two side plates; the cabinet further comprise a top cover extending from the rear plate, and the top cover is substantially parallel to the bottom plate; and the top cover, the rear plate, and the two side plates cooperatively define a receiving space for receiving the temperature control module.

15. The vending machine of claim 14, wherein the dividing member, the compressor, and the condenser are received in the receiving space, and the evaporator is located above the top cover.

16. The vending machine of claim 14, wherein top cover comprises a mounting plate substantially parallel to the rear plate, the mounting plate defines a receiving slot towards the mounting plate, and a part of each of the two supports is received in the receiving slot.

17. The vending machine of claim 14, wherein a height of the top cover is substantially equal to a distance between the dividing member and a bottom surface of the evaporator.

18. The vending machine of claim 14, wherein the sliding rail is secured to the bottom plate, a sliding channel is defined by the sliding rail and the bottom plate, and the wheel is slidably received in the sliding channel; the bottom plate comprises a blocking member, the blocking member comprises two blocking pieces, and the base is engaged between the two blocking pieces.

19. The vending machine of claim 14, further comprising a heat insulation plate and a sealing washer, wherein each of the two side plates comprises a flange; the receiving space defines an opening; and the sealing washer is secured to the mounting plate and the flange and covers the opening.
